(19) United States
(12) Patent Application Publication
(10) Pub. No.: US 2019/0002212 A1
(43) Pub. Date: Jan. 3, 2019

(54) STOPPER

(71) Applicant: FANUC CORPORATION, Yamanashi (JP)

(72) Inventor: Takashi ITSUKAICHI, Yamanashi (JP)

(21) Appl. No.: 16/019,543

(22) Filed: Jun. 27, 2018

(30) Foreign Application Priority Data
Jun. 28, 2017 (JP) 2017-126257

(51) Int. Cl. B65G 47/88

(52) U.S. Cl. CPC B65G 47/8823; B65G 2249/04

(57) ABSTRACT

A stopper configured to stop an object conveyed by a conveyor, includes a discharge portion configured to discharge air toward the conveyed object.

### CROSS-REFERENCE TO RELATED APPLICATION

This application is based upon and claims the benefit of priority from Japanese Patent Application No. 2017-126257 filed on Jun. 28, 2017, the contents of which are incorporated herein by reference.

### BACKGROUND OF THE INVENTION

### Field of the Invention

The present invention relates to a stopper for stopping an object conveyed by a conveyer.

### Description of the Related Art

Japanese Laid-Open Patent Publication No. 2011-236049 discloses a stopper for restraining the movement of an object conveyed by a roller conveyor.

### SUMMARY OF THE INVENTION

In the technology described in Japanese Laid-Open Patent Publication No. 2011-236049, when a container loaded with a plurality of components and conveyed by the conveyer collides with a stopper, there are several problems that the components in the container are displaced in position, and that the components fall out of a container, and so on.

The present invention has been made in order to solve the aforementioned problems, and it is an object of the present invention to provide a stopper capable of mitigating a shock exerted when an object conveyed by a conveyer is stopped.

In one aspect of the present invention, a stopper is configured to stop an object conveyed by a conveyor, wherein the stopper includes a discharge portion configured to discharge air toward the conveyed object.

According to the present invention, it is possible to mitigate a shock exerted when the conveyed object is stopped.

The above and other objects, features and advantages of the present invention will become more apparent from the following description when taken in conjunction with the accompanying drawings, in which a preferred embodiment of the present invention is shown by way of an illustrative example.

### BRIEF DESCRIPTION OF THE DRAWINGS

FIG. 1 is a schematic side view showing the construction of a conveyer;

FIG. 2 is a schematic side view of the conveyor showing a state that a container moving on the conveyor is stopped;

FIG. 3 is a schematic side view of the conveyor showing a state that the position of the container after being stopped is fixed; and

FIG. 4 is a schematic side view of the conveyor showing a state that the stopped container is moved again.

### DESCRIPTION OF THE PREFERRED EMBODIMENTS

### First Embodiment

### [Construction of Conveyor]

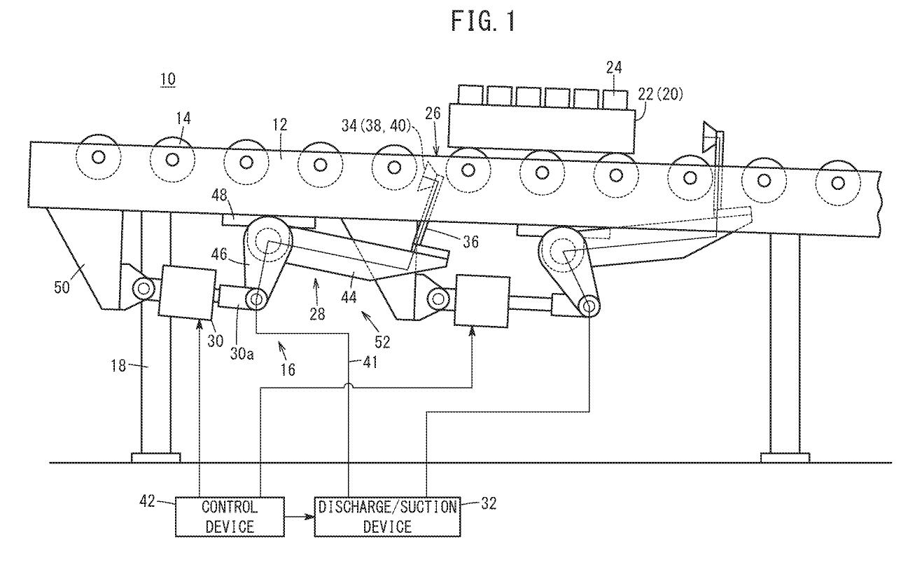

FIG. 1 is a schematic side view showing the construction of a conveyor 10. The conveyor 10 is a non-powered roller conveyor.

The conveyor 10 has a pair of rails 12, a plurality of rollers 14, and plural sets of stopper mechanisms 16. The pair of rails 12 are provided to extend in parallel to each other in a separated state. The rails 12 are supported by a plurality of pillars 18 and are installed to become a downward slope from one end side toward the other end side of the rails 12. The gradient angle of the rails 12 is two (2) degrees, for example. The plurality of rollers 14 are arranged between the pair of rails 12 at substantially regular intervals and are rotatably supported by the rails 12.

When the container 22 as a conveyed object 20 is put on the rollers 14 of the conveyor 10, the container 22 moves by its own weight from one end side toward the other end side of the conveyor 10. For example, components 24 to be supplied to an assembling robot (not shown) are loaded in the container 22.

Each set of stopper mechanisms 16 has a stopper 26, a link mechanism 28, an actuator 30, and a discharge/suction device 32. The plurality of stopper mechanisms 16 are provided on the conveyer 10. Hereafter, the construction and operation of one stopper mechanism 16 will typically be described in detail. The stopper 26 has discharge/suction portions 34 and a support portion 36. The support portion 36 is made of a plate-like member and is provided with the discharge/suction portions 34 at its upper portion. The discharge/suction portions 34 are plural in number and are arranged side by side in the width direction of the support portion 36. Each of the discharge/suction portions 34 is configured by a discharge portion 38 for discharging air and a suction portion 40 for drawing air, which are integrated with each other. The discharge/suction portions 34 are mounted on the support portion 36 and are able to discharge air toward the upstream side of the conveyor 10. The discharge/suction portions 34 are connected to the discharge/suction device 32 by a pipe 41. The discharge/suction device 32 is driven in response to a control signal from a control device 42. By the switching of a valve (not shown), the discharge/suction device 32 is able to discharge compressed air to the discharge/suction portions 34 and to draw air from the discharge/suction portions 34.

The link mechanism 28 has a root portion of a driven arm 44 and a root portion of a drive arm 46 secured integrally to be formed in a substantially L-shape. A portion connecting the root portion of the driven arm 44 and the root portion of the drive arm 46 is pivotably supported by a bracket 48 mounted on bottom portions of the rails 12. The stopper 26 is fixed on an end portion of the driven arm 44. An end portion of the drive arm 46 is connected to a drive shaft 30a of the actuator 30.

The actuator 30 is fixed to a bracket 50 mounted on the bottom portions of the rails 12. The drive shaft 30a of the actuator 30 operates to reciprocate linearly. The actuator 30 is driven in response to a control signal from the control device 42. When the actuator 30 is driven to push the drive arm 46 by the drive shaft 30a, the driven arm 44 is pivoted in a direction to come close to the rollers 14 to raise the stopper 26 up. Thus, the discharge/suction portions 34 of the stopper 26 pass through between the rollers 14 and are moved above the upper surfaces of the rollers 14. Conversely, when the actuator 30 is driven to pull the drive arm 46 by the drive shaft 30a, the driven arm 44 is pivoted in a direction away from the rollers 14, and thus the stopper 26 is lowered. As a result, the discharge/suction portions 34 of the stopper 26 pass through between the rollers 14 and are moved below the upper surfaces of the rollers 14. Incidentally, the link mechanism 28 and the actuator 30 constitute a drive portion 52.

### [Operation of Stopper Mechanism]

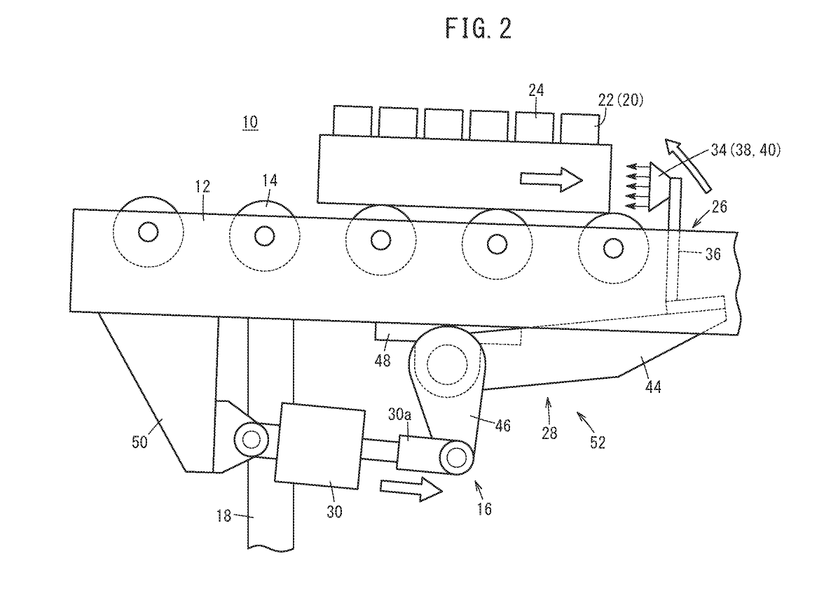

FIG. 2 is a schematic side view of the conveyor 10 showing a state that the container 22 moving on the conveyor 10 is stopped. When the container 22 is to be stopped, the actuator 30 is driven to push the drive arm 46 by the drive shaft 30a. Thus, the discharge/suction portions 34 of the stopper 26 are moved above the upper surfaces of rollers 14. Then, the discharge/suction device 32 is driven to discharge air from the discharge/suction portions 34 toward the container 22. As a result, the container 22 being conveyed on the conveyor 10 is gradually decelerated by air pressure and is stopped. Accordingly, it is possible to mitigate a shock exerted on the container 22 when the same is stopped.

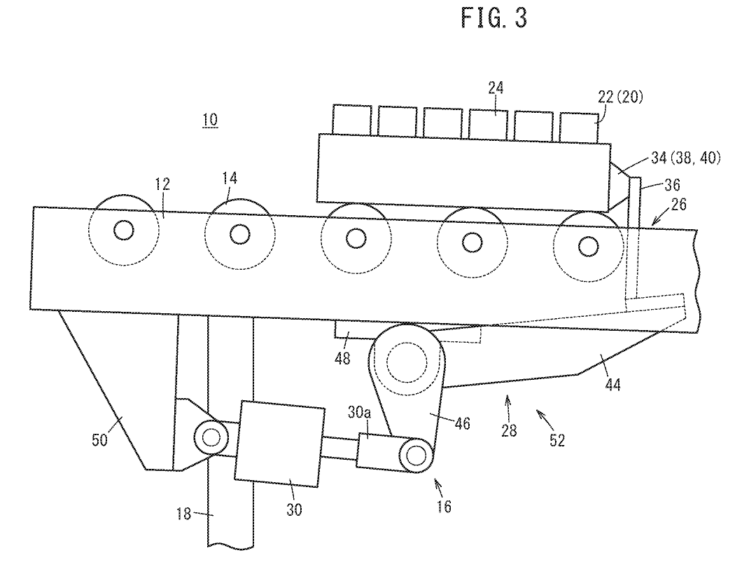

FIG. 3 is a schematic side view of the conveyor 10 showing a state that the position of the container 22 after being stopped is fixed. When the container 22 is to be fixed, air is drawn from the discharge/suction portions 34 to attach to the container 22 by suction. If the discharge/suction portions 34 were not provided on the support portion 36, the container 22 would be stopped by the support portion 36 of the plate-like member. In this case, the container 22 would go back slightly toward the upstream side by the shock of a collision of the container 22 with the support portion 36, whereby the container 22 would be stopped in the state of being not in abutment on the support portion 36.

In the present embodiment, because the discharge/suction portions 34 attach to the container 22 by suction, it is possible to stop the container 22 in the state that the container 22 is closely attached to the discharge/suction portions 34. Thus, it is possible to improve the accuracy in stop position of the container 22. Further, because the container 22 is fixed, the container 22 does not move even if, for example, an external force is exerted on the container 22 after the container 22 is stopped.

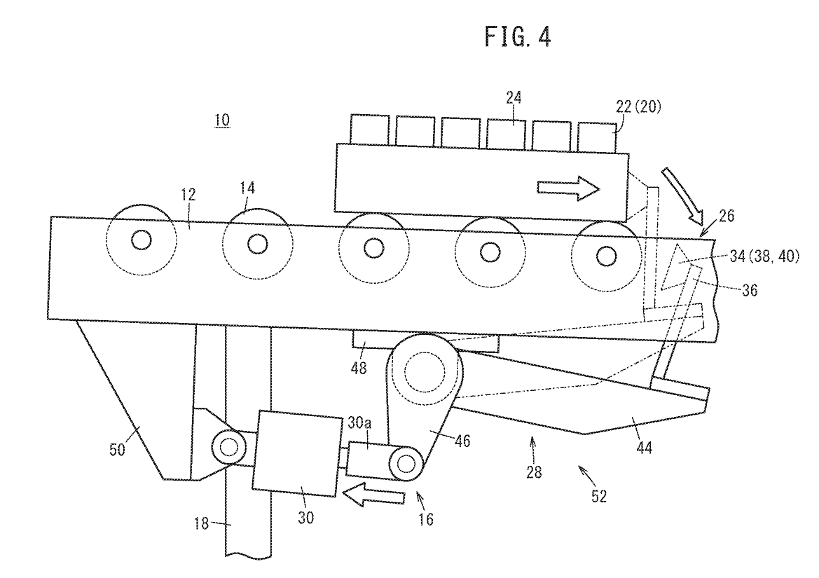

FIG. 4 is a schematic side view of the conveyor 10 showing a state that the stopped container 22 is moved again. When the container 22 is to be moved, the actuator 30 is driven while the discharge/suction portions 34 attaches to the container 22. Then, the drive arm 46 is drawn by the drive shaft 30a to move the discharge/suction portions 34 of the stopper 26 in the conveyance direction of the container 22. Consequently, it is possible to assist the movement of the container 22, and hence to move the container 22 reliably. Assisting the movement of the container 22 is particularly effective where the inclination angle of the conveyor 10 is gentle as in the present embodiment.

### [Operational Effects]

In the prior art, in order to stop the container 22 conveyed on the conveyor 10, the container 22 is brought into collision with the stopper 26 on the downstream side of the container 22. However, when the container 22 comes into collision with the stopper 26, there is a problem that the shock at the time of collision causes the components 24 in the container 22 to be displaced in position and also causes the components 24 to fall out of the container 22, and so on.

By providing the stopper 26 with a shock absorber or the like, it is possible to mitigate the shock exerted when the container 22 is stopped. However, since the shock absorber is unable to stably secure the position of the container 22 after the container 22 is stopped, it is necessary to additionally provide a clamping mechanism or the like for securing the container 22.

To this end, in the present embodiment, the stopper 26 has the discharge portions 38 for discharging air toward the container 22 (the conveyed object 20). Thus, the object 20 conveyed on the conveyor 10 can be gradually decelerated and stopped by the air pressure, and therefore, it is possible to mitigate the shock exerted when the container 22 is stopped.

Further, in the present embodiment, the stopper 26 has the suction portions 40 for attaching to the container 22 (the conveyed object 20). Thus, since the container 22 can be stopped in the state of being closely attached to the suction portions 40, it is possible to improve the accuracy in stop position of the container 22.

Further, in the present embodiment, the discharge portion 38 and the suction portion 40 are integrated with each other to constitute the discharge/suction portions 34. Thus, in comparison with a construction that the discharge portion 38 and the suction portion 40 are provided separately, it is possible to suppress the number of components.

Further, in the present embodiment, the suction portions 40 attach to the container 22 (the conveyed object 20) and fix the position of the container 22. Thus, since the container 22 does not move after being stopped, it is possible for an assembling robot, for example, to easily grip the components 24 loaded in the container 22.

Further, in the present embodiment, in the state that the suction portions 40 attach to the container 22 (the conveyed object 20), the drive portion 52 moves the suction portions 40 in the conveyance direction of the container 22. Thus, it is possible to assist the starting movement of the container 22 and hence, to move the container 22 reliably.

### First Modification

Although in the present embodiment, the conveyor 10 is the non-powered roller conveyor, some or all of the rollers 14 may be rotated by power.

### Second Modification

Although in the present embodiment, the plurality of discharge/suction portions 34 are provided on the support portion 36, only a single discharge/suction portion 34 may be provided.

Although the present invention has been described with reference to the embodiments, the technical scope of the present invention should not be limited to the scope described in the above embodiments. It goes without saying that various modifications and/or improvements can be added to the above embodiments.

### Technical Ideas Obtained from the Embodiments

The technical ideas that can be grasped from the foregoing embodiments will be described below.

A stopper (26) configured to stop an object (20) conveyed by a conveyor (10) includes a discharge portion (38) configured to discharge air toward the conveyed object (20). With this construction, it is possible to mitigate a shock exerted when the conveyed object (20) is stopped.

The stopper (26) may further include a suction portion (40) configured to attach to the conveyed object (20) by suction. With this construction, it is possible to improve the accuracy in stop portion of the conveyed object (20).

In the stopper (26), the discharge portion (38) and the suction portion (40) may be integrated with each other. With this construction, the number of components can be suppressed.

In the stopper (26), the suction portion (40) may be configured to attach to the conveyed object (20) by suction, to secure the position of the conveyed object (20). With this construction, it is possible to restrain the movement of the conveyed object (20) after the same is stopped.

The stopper (26) may further include the drive portion (52) configured to move the suction portion (40) in the conveyance direction of the conveyed object (20), and the drive portion (52) may be configured to move the suction portion (40) in the conveyance direction in the state that the suction portion (40) attaches to the conveyed object (20) by suction. With this construction, it is possible to move the conveyed object (20) reliably.

What is claimed is:

1. A stopper configured to stop an object conveyed by a conveyor, the stopper comprising a discharge portion configured to discharge air toward the conveyed object.

2. The stopper according to claim 1, further comprising a suction portion configured to attach to the conveyed object by suction.

3. The stopper according to claim 2, wherein the discharge portion and the suction portion are integrated with each other.

4. The stopper according to claim 2, wherein the suction portion is configured to attach to the conveyed object by suction, to secure a position of the conveyed object.

5. The stopper according to claim 2, further comprising a drive portion configured to move the suction portion in a conveyance direction of the conveyed object,
wherein the drive portion is configured to move the suction portion in the conveyance direction in a state that the suction portion attaches to the conveyed object by suction.
